(19) United States
(12) Patent Application Publication
(10) Pub. No.: US 2015/0077419 A1
(43) Pub. Date: Mar. 19, 2015

(54) VISUALIZATION OF DATA RELATED TO UNSTRUCTURED TEXT

(71) Applicant: International Business Machines Corporation, Armonk, NY (US)

(72) Inventors: Kelly Abuelsaad, Somers, NY (US); Soobaek Jang, Hamden, CT (US); Daniel C. Krook, Fairfield, CT (US)

(73) Assignee: International Business Machines Corporation, Armonk, NY (US)

(21) Appl. No.: 14/031,541

(22) Filed: Sep. 19, 2013

(51) Int. Cl. G06T 11/20

(52) U.S. Cl. CPC G06T 11/206
USPC 345/440

(57) ABSTRACT

In a method for visualizing data related to unstructured text, a computer identifies at least two data points in a portion of unstructured text of a document, a relationship between the at least two data points, and a label for each of the at least two data points. The computer determines a type of graph to create based on the identified data. The computer causes the at least two data points and the label for each of the at least two data points, and the relationship between the at least two data points to be visualized on a graph. The computer causes a modified graph based on the received instructions to be visualized. The computer causes the modified graph to be displayed in the document having the unstructured text.

### FIELD OF THE INVENTION

The present invention relates generally to data processing, and more particularly to analyzing and visualizing data related to unstructured text.

### BACKGROUND OF THE INVENTION

A picture is worth a thousand words, particularly when one is trying to understand and gain insights from data. Large volumes of written data can be overwhelming and confusing at first sight. A compelling graphic allows one to quickly visualize data and draw conclusions from the data. It is especially relevant when determining relationships among thousands or even millions of variables and determining their relative importance.

Unstructured information may be categorized as information requiring interpretation and analysis in order to approximate and extract an intended meaning. In other words, unstructured text is any data residing disorganized outside a database. One such example is a natural language document, such as unstandardized speech.

Text analytics describes a set of linguistic, statistical, and machine learning techniques that model and structure the information content of textual sources for business intelligence, exploratory data analysis, or research.

### SUMMARY

Aspects of embodiments of the present invention disclose a method, computer program product, and computer system for allocating and storing application data for applications of mobile devices. A computer identifies at least two data points in a portion of unstructured text of a document, a relationship between the at least two data points, and a label for each of the at least two data points. The computer determines a type of graph to create based on the at least two data points, the relationship between the at least two data points, and the label for each of the at least two data points. The computer causes the at least two data points and the label for each of the at least two data points, and the relationship between the at least two data points to be visualized on a graph of the type of graph determined. The computer causes the graph to be displayed in the document having the unstructured text.

### BRIEF DESCRIPTION OF THE SEVERAL VIEWS OF THE DRAWINGS

FIG. 1 is a functional block diagram illustrating a computing device, in accordance with the depicted embodiment of the present invention.

FIG. 2 is a flowchart depicting operational steps of a data visualization program, executing within the computing device of FIG. 1, for visualizing data related to unstructured text, in accordance with the depicted embodiment of the present invention.

FIG. 3A-C depicts an exemplary unstructured text and exemplary visualizations of data related to the unstructured text, in accordance with the depicted embodiment of the present invention.

FIG. 4 depicts a block diagram of components of the computing device of FIG. 1, in accordance with the depicted embodiment of the present invention.

### DETAILED DESCRIPTION

Information retrieval plays an increasingly prominent role in both academic and industrial scientific research but currently suffers from a lack of numeric search capability in general and a lack of numeric data extraction from unstructured text specifically. Since an estimated 85% of corporate information and 95% of global information is unstructured, sophisticated information extraction techniques are required to transform such content into usable data. Regardless of the amount of data, one of the best ways to discern important relationships is through advanced analysis and high-performance data visualization. Fast, even immediate, analysis can be used to present results in various ways that showcase trends and patterns.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

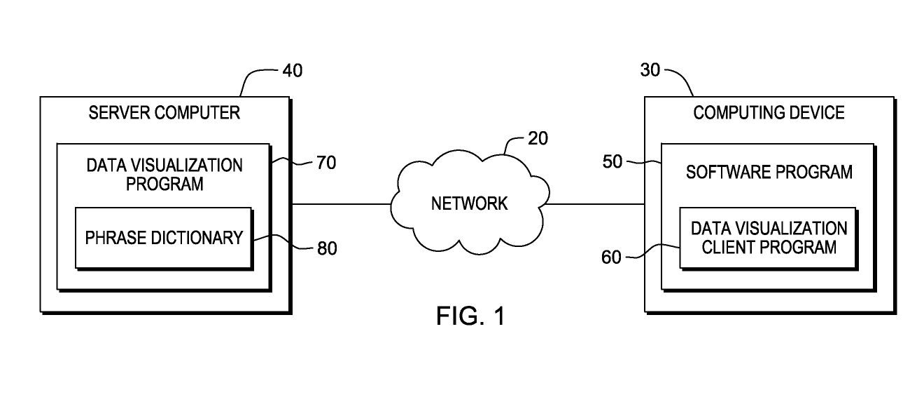

The present invention will now be described in detail with reference to the Figures. FIG. 1 depicts a diagram of distributed data processing environment 10 in accordance with one embodiment of the present invention. FIG. 1 provides only an illustration of one embodiment and does not imply any limitations with regard to the environments in which different embodiments may be implemented.

In the depicted embodiment, distributed data processing environment 10 includes two or more of client computers 30 and server computer 40 interconnected over network 20. Network 20 may be a local area network (LAN), a wide area network (WAN) such as the Internet, a combination of the two or any combination of connections and protocols that will support communications between client computers 30 and server computer 40, in accordance with embodiments of the invention. Network 20 may include wired, wireless, or fiber optic connections. Distributed data processing environment 10 may include additional server computers, client computers, or other devices not shown.

Client computer 30 may be a desktop computer, laptop computer, tablet computer, personal digital assistant (PDA), or smart phone. In general, client computer 30 may be any electronic device or computing system capable of executing computer program instructions. In the exemplary embodiment, client computer 30 includes software program 50, data visualization client program 60, and phrase dictionary 80. While in FIG. 1 software program 50 and data visualization client program 60 are included within client computer 30, one of skill in the art will appreciate that the computer can access software program 50 and data visualization client program 60.

Server computer 40 may be a management server, web server, or any other electronic device or computing system capable of receiving and sending data, in accordance with embodiments of the invention. In other embodiments, server computer 40 may represent a server computing system utilizing multiple computers as a server system, such as in a cloud computing environment. In the depicted embodiment, server computer 40 includes data visualization program 70 and phrase dictionary 80.

Software program 50 executes on client computer 30. In the depicted embodiment, software program 50 is a generic software program that includes sequences of instructions written to perform a specified task with client computer 30. For example, software program 50 is a word processing program. In another example, software program 50 may be an e-mail client program.

Data visualization client program 60 operates to visualize data related to unstructured text. Unstructured text is information that either does not have a pre-defined data model or is not organized in a pre-defined manner. Unstructured information is typically text-heavy, but may contain data such as numeric values. In one embodiment, data visualization client program 60 is a plugin. In the depicted embodiment, data visualization client program 60 is a plugin for software program 50. In other embodiments, data visualization client program 60 is a plugin for a web browser, word processor, etc. In another embodiment, data visualization client program 60 is a separate program that can communicate with software program 50. Data visualization client program 60 could also be a stand alone program that can visualize data related to unstructured text.

In the depicted embodiment, data visualization client program 60 accesses data visualization program 70 over network 20 in order to determine rules to identify numeric values, relationships between numeric values, and labels for numeric values. Data visualization client program 60 requests the rules from data visualization program 70 over network 20.

Data visualization program 70 executes on server computer 40. In the depicted embodiment, data visualization 70 operates to access rules to identify numeric values, relationships between numeric values, and labels for numeric values. Data visualization program 70 sends the rules to data visualization client program 60 over network 20. In the depicted embodiment, data visualization program 70 receives a request from data visualization client program 60 for the rule to identify numeric values, relationships between numeric values, and labels for numeric values. Data visualization program 70 accesses phrase dictionary 80 to determine the rules to identify numeric values, relationships between numeric values, and labels for numeric values. In one embodiment, data visualization program 70 sends the rules to identify numeric values, relationships between numeric values, and labels for numeric values to data visualization client program 60 over network 20. In another embodiment, data visualization program 70 sends keywords to identify numeric values, relationships between numeric values, and labels for numeric values to data visualization client program 60 over network 20. In yet another embodiment, data visualization program 70 sends graphing rules that describe how to visualize numeric values, relationships between to numeric values, and labels for numeric values to data visualization client program 60 over network 20.

In the depicted embodiment, phrase dictionary 80 is a component of data visualization client program 60. In one embodiment, phrase dictionary 80 is a pre-defined collection of rules, keywords, and symbols that data visualization client program 60 will use to analyze a document and create a graph. For example, phrase dictionary 80 defines the keyword “seventy seven” as the numeric value 77 and identifies the numeric value 77 as a data point. Phrase dictionary 80 also contains graphing rules that describe how to graph data points based on relationship phrases related to the data points.

In the depicted embodiment, phrase dictionary 80 is part of data visualization client program 60. In other embodiments, phrase dictionary 80 is a separate file or repository that can be accessed by data visualization client program 60.

In one embodiment, phrase dictionary 80 may be modified by a user utilizing software program 50. The user, using software program 50, can access phrase dictionary 80 over network 20. The user may select a “modify phrase dictionary” option and modify the pre-defined rules stored by phrase dictionary 80. For example, the user can add numeric values, words, and symbols to phrase dictionary 80. The user may also remove numeric values, words, and symbols from phrase dictionary 80. The user can then save the modification to phrase dictionary 80.

Data visualization client program 60 analyzes a document that contains unstructured text, such as a word document, e-mail message, presentation, or any other type of document. For example, data visualization client program 60 analyzes a finished document such as an e-mail message received by software program 50. In another example, data visualization client program 60 analyzes a document in real time, such as an e-mail being typed by a user utilizing software program 50.

In one embodiment, data visualization client program 60 analyzes a document using text analytics. Data visualization client program 60 analyzes a document by searching for data points that can be visualized. For example, data points can include monetary values or any other numeric value. In the depicted embodiment, data visualization client program 60 uses the rules received from data visualization program 70 to identify data points that can be visualized.

Data visualization client program 60 determines relationships between the data points that are identified in the unstructured text. In the depicted embodiment, data visualization client program 60 uses the rules received from data visualization program 70 to identify relationship phrases that describe a relationship between the identified data points. For example, rules may identify relationship phrases as words such as “in comparison with,” “compared to,” “increase,” “decrease,” and “alternatively.”

In the depicted embodiment, data visualization client program 60 is capable of reading the rules sent by data visualization program 70 and determining how the numeric values should be labeled and plotted based on the rules.

Data visualization client program 60 determines labels for the data points. In the depicted embodiment, data visualization client program 60 uses the rules received from data visualization program 70 to identify labels for the identified data points. For example, data visualization client program 60 searches for the keyword “percentage” and for the symbol “%” to determine if a data point is a percentage. In another embodiment, rules describe the proximity of keywords, numeric values, and symbols in order to determine labels of data points. For example, a rule may state that when the symbol “$” appears before a numeric value indicates that the numeric value is a monetary value.

In another example, a rule may be that a noun following a numeric value may be a label. As data visualization client program 60 searches the sentence, “The company sold 1218 computers in April,” data visualization client program 60 uses the rules to identify “1218” as the data point and the following word, “computers,” as a likely label. Data visualization client program 60 may then compare the word “computers” to a list of nouns stored by phrase dictionary 70 in order to determine that “computers” is the appropriate label for the data point “1218.”

In another embodiment, data visualization client program 60 can use the keywords that determine relationships to correctly label each data point and to determine if data points are related to each other. For example, if unstructured text includes the phrase “the class average increased from 76% to 84%,” data visualization client program 60 determines that there are two data points in the phrase and that the two data points are the two numeric values 76 and 84. Data visualization client program 60 determines that the relationship phrase for the data points is the word “increased.” Based on the definition of the relationship phrase “increased”, data visualization client program 60 determines that there is an increase between the data points. Data visualization client program 60 also determines that the data points share the same label, which is a percentage of the class average.

In the depicted embodiment, data visualization client program 60 has graphing capabilities and data visualization client program 60 visualizes the data points, relationships and labels determined from the unstructured text. Data visualization client program 60 requests graphing rules from data visualization program 70. Data visualization client program 60 uses the graphing rules to create a graph. In one embodiment, based on the graphing rules, data visualization client program 60 organizes the data points and labels in appropriate columns in a spreadsheet. In another embodiment, data visualization client program 60 stores the data points and labels in a table in the memory of client computer 30. Data visualization client program 60 also labels the axes of the graph based on the determined labels of the data points based on the graphing rules. In another embodiment, data visualization client program 60 sends data points, labels, and graphing instructions to a graphing program residing on client computer 30.

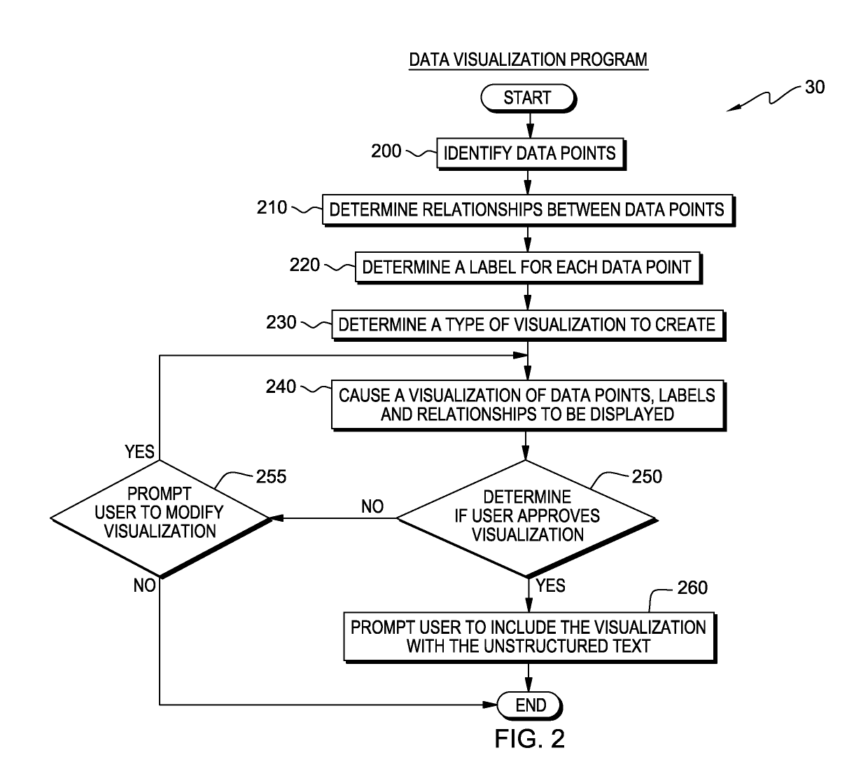

FIG. 2 is a flowchart depicting operational steps of a data visualization client program 60, executing on client computer 30 of FIG. 1, for visualizing data related to unstructured text, in accordance with one embodiment of the present invention.

In one embodiment, initially, a user composes a word document with unstructured text using software program 50. In the depicted embodiment, data visualization client program 60 analyzes unstructured text of the word document after the word document is typed. In another embodiment, data visualization client program 60 operates to analyze unstructured text of the word document in real time as the user types the word document. In one embodiment, data visualization client program 60 requests rules and keywords to identify numeric values, relationship phrases, and labels from data visualization program 70. Data visualization program 70 accesses phrase dictionary 80 and determines the rules and keywords to identify numeric values, relationship phrases, and labels. Data visualization program 70 sends the rules and keywords to identify numeric values, relationship phrases, and labels to data visualization program 60 over the network. In another embodiment, data visualization client program 60 accesses phrase dictionary 80 and determines the rules and keywords to identify numeric values, relationship phrases, and labels. In another embodiment, data visualization client program 60 also requests graphing rules from data visualization program 70. Data visualization program 70 accesses phrase dictionary 80 and determines graphing rules. Data visualization program 70 sends the graphing rules to data visualization program 60 over the network.

In step 200, data visualization client program 60 identifies data points in the unstructured text. Data visualization client program 60 uses the rules and keywords to identify data points in the unstructured text. A rule may identify words describing numeric values as the numeric values the words describe. For example, the word “three” describes the numeric value 3.

In step 210, data visualization client program 60 determines relationships between the data points. In the depicted embodiment, data visualization client program 60 uses the rules and keywords to identify relationship phrases. A relationship phrase may include the words “decrease”, “increase,” and “compared with.” Data visualization client program 60 analyzes the unstructured text for keywords and phrases that have been defined as relationship phrases.

In the depicted embodiment, data visualization client program 60 also determines the meaning of each relationship phrase. Data visualization client program 60 uses the rules to determine the meaning of the determined relationship phrases. In an example, data visualization client program 60 identifies the relationship phrase “compared with.” Data visualization client program 60 determines from a rule that the phrase “compared with” indicates that at least one numeric value before the phrase is being evaluated against at least one numeric value after the phrase.

In step 220, data visualization client program 60 determines a label for each data point determined in step 200. In the depicted embodiment, data visualization client program 60 uses the rules and keywords to identify labels for data points. Data visualization client program 60 searches the unstructured text for the keywords and symbols stored in phrase dictionary 80 that are defined as labels. A label may be a unit of measurement, such as a length or magnitude, a monetary measurement, such as dollars or cents, or any type of unit. For example, data visualization client program 60 determines that the symbol “$” indicates that the numeric value associated with it is a monetary value.

In another embodiment, data visualization client program 60 uses rules to determine labels for identified data points. A rule may define a label as a noun that immediately follows a data point. For example, in the phrase “47 cats were rescued by the pet shelter”, data visualization client program 60 determines that the data point in the phrase is the numeric value “47.” Data visualization client program 60 then uses the rule to determine that the label for the data point “47” is the word “cats,” which is the noun immediately following the data point in the phrase of unstructured text.

In step 230, data visualization client program 60 determines a type of visualization to create. In the depicted embodiment, data visualization client program 60 uses the identified data points, determined relationships, and determined labels to determine a type of visualization to create. For example, data visualization client program 60 determines, from the labels determined from the unstructured text, that the data points determined from the unstructured text can be organized into two separate groups of data points. Data visualization client program 60 determines that the two separate groups of data points are monetary values that represent first quarter sales from two different companies. Data visualization client program 60 determines, from the relationship phrases determined from the unstructured text, that the two separate groups of data points are being compared.

In one embodiment, data visualization client program 60 uses graphing rules to determine how to visualize determine how to visualize the determined data points, relationships, and labels. Graphing rules specify the type of visualization data visualization client program 60 will create based on the relationship phrases determined by data visualization client program 60. For example, a graphing rule may be that a line graph is created when the relationship phrase “increased” is determined. In another example, a graphing rule may be that, when the relationship phrase “compared to” is used for more than two separate groups of data points, a pie graph is created.

For example, if the words used as relationships between values are action-oriented such as “increased to” or “down from”, then data visualization client program 60 causes a line graph to be displayed on computing device 20. In another example, the words that are used as relationships between the data may be more descriptive of pieces of a whole object, i.e they may be discussing revenue, where “Software accounted for 50% of revenue, hardware accounted for 40% of revenue, and consulting accounted for 10% of revenue”, then data visualization client program 60 causes a pie graph to be displayed on computing device 20.

In step 240, data visualization client program 60 causes a visualization of the determined data points, labels, and relationships to be displayed on client computer 30. In the depicted embodiment, data visualization client program 60 accesses phrase dictionary 80 to determine graphing rules related to the determined data points, labels, and relationships. Data visualization client program 60 uses the graphing rules to determine how to correlate the data points and labels. For example, data visualization client program 60 uses the graphing rules to determine the axes of a graph to be created by data visualization client program 60. In one example, the data points and labels are organized in a spreadsheet to be used to create a graph using the graphing rules. In another embodiment, data visualization client program 60 stores the data points and labels in a table in the memory of client computer 30. In one embodiment, the graphing rules are pre-defined. In another embodiment, the graphing rules are defined by the user.

Data visualization client program 60 causes a graph that includes the data points, labels, and relationships between the data points to be displayed on client computer 30. In the depicted embodiment, data visualization client program 60 displays a modeless window containing the graph. A modeless window is a window that does not requires a user to interact with it before the user can return to operating a parent application (e.g. data visualization client program 60). The user can, for example, continue to interact with data visualization client program 60, software program 50, or any other program on client computer 30 while the modeless window containing the graph is open. In one embodiment, data visualization client program 60 causes a modal window containing a bar graph to be displayed on client computer 30. In another embodiment, data visualization client program 60 causes a modal window containing a pie graph to be displayed on client computer 30.

In step 250, data visualization client program 60 determines if the user approves of the visualization of the data points, labels, and relationships displayed. In the depicted embodiment, data visualization client program 60 prompts the user to approve or disapprove of the visualization. For example, data visualization client program 60 prompts the user by causing a dialog box to display on client computer 30. A dialog box is a type of window used to enable reciprocal communication, or “dialog” between a computer and its user. A dialog box may communicate information to the user, prompt the user for a response, or both. A dialog box is most often used to provide the user with the means for specifying how to implement a command or to respond to a question or an “alert.” The user uses the dialog box to indicate whether the user approves or disapproves of the visualization. If the user approves of the visualization, data visualization client program 60 proceeds to step 260 (decision 250, Yes branch). If the user does not approve of the visualization, data visualization client program 60 proceeds to decision 255 (decision 250, No branch).

In decision 255, data visualization client program 60 prompts the user to modify the visualization. For example, data visualization client program 60 prompts the user by causing a dialog box to display on client computer 30. If the user does not modify the graph (decision 255, No branch), data visualization client program 60 ends. In one embodiment, the user modifies a graph by selecting the graph and opening the spreadsheet that contains the data points and labels used to create the graph. For example, the user removes ten data points and modifies one label. The user saves the spreadsheet and data visualization client program 60 proceeds to step 240 (decision 255, Yes branch). Data visualization client program 60 causes a visualization of the modified data points, labels, and relationships to be displayed on client computer 30. In the depicted embodiment, data visualization client program 60 displays a modeless box containing the modified graph on client computer 30.

Data visualization client program 60 proceeds to step 250 and prompts the user to approve or disapprove of the modified visualization. For example, data visualization client program 60 prompts the user by causing a dialog box to display on client computer 30. If the user approves of the visualization, data visualization client program 60 proceeds to step 260 (decision 250, Yes branch). If the user rejects the modified graph (decision 250, No branch), data visualization program proceeds to decision 255 again.

In step 260, data visualization client program 60 prompts the user to include the graph with the unstructured text. In the depicted embodiment, data visualization client program 60 prompts the user to include the graph in the document that contains the unstructured text. For example, data visualization client program 60 prompts the user by causing a dialog box to display on client computer 30. In the depicted embodiment, the user indicates to data visualization client program 60 to include the graph in the document. For example, the user selects, as an option displayed in the dialogue box, to include the graph in the document. Data visualization client program 60 causes the graph to be displayed in the document. For example, data visualization client program 60 embeds the graph into the document. In another example, the graph is displayed in the margin of the document. The user may select the graph and move the graph to different location in the document. In yet another example, the graph may be displayed in another part of the document.

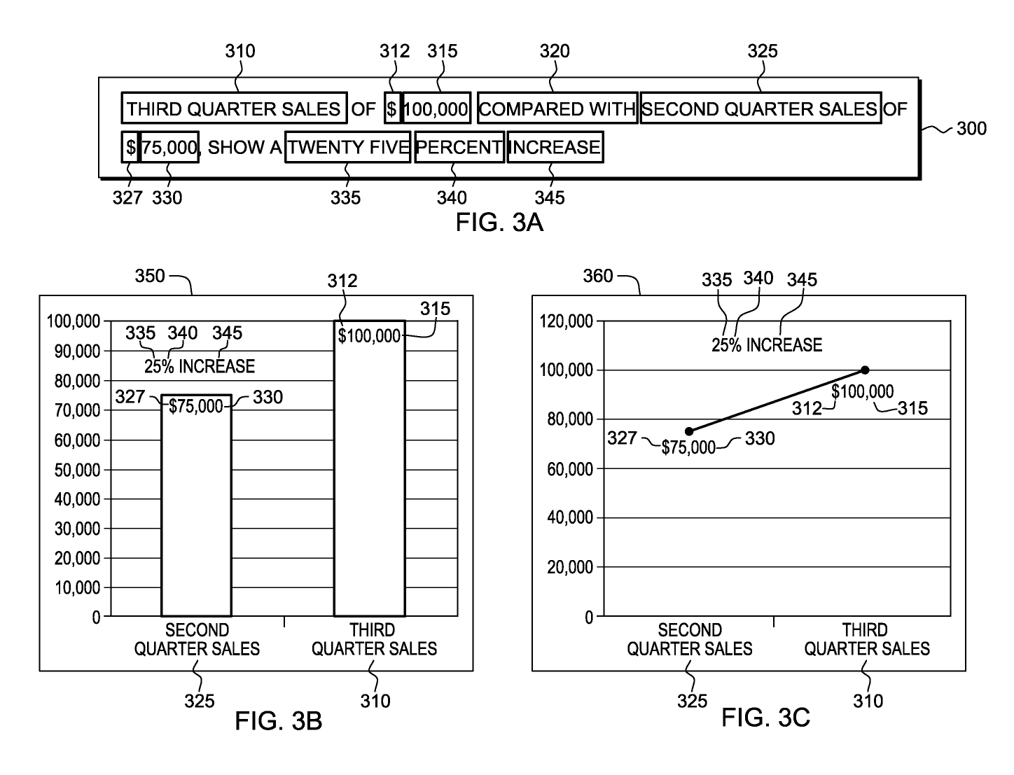

FIG. 3A-C depicts an exemplary unstructured text and exemplary visualizations of data related to the unstructured text, in accordance with the depicted embodiment of the present invention.

FIG. 3A depicts exemplary unstructured text 300. Unstructured text 300 is exemplary unstructured text that is analyzed by data visualization client program 60. In the depicted embodiment, data visualization client program 60 analyzes unstructured text 300 to identify pre-defined keywords and symbols.

In the depicted embodiment, data visualization client program 60 determines that data points 315, 330, and 335 are data points. Data visualization client program 60 determines relationships between the data points by identifying relationship phrases. For example, a rule may define some relationships by the proximity of each numeric value to the relationship phrase. In another example, a rule defines a relationship by the order of numeric values. In yet another example, a relationship phrase is a pre-defined keyword. Data visualization client program 60 determines relationship phrase 320 describes the relationship between data point 315 and data point 330, and relationship phrase 345 indicates that numeric value 335 quantifies the relationship between numeric value 315 and numeric value 330.

Data visualization client program 60 determines that labels 310, 325, and 340 are labels. Data visualization client program 60 determines that label 310 is the label for numeric value 315, label 325 is the label for numeric value 330, and label 340 is the label for numeric value 335. In this embodiment, data visualization client program 60 determines the label for each numeric value based on the proximity of the words comprising the label to the numeric value and based on pre-defined keywords.

Data visualization client program 60 determines that symbols 312 and 327 are monetary symbols. Data visualization client program 60 identifies symbols 312 and 327 and, based on the pre-defined symbol of “$”, data visualization client program 60 determines that symbols 312 and 327 are monetary symbols. Based on the rules, data visualization client program 60 determines that the numeric values immediately following symbols 312 and 327 (e.g. data points 315 and 330) are monetary values.

FIG. 3B depicts bar graph 350 created by data visualization client program 60 that includes the data points and labels identified in unstructured text 300. In the depicted embodiment, data visualization client program 60 uses graphing rules to determine a type of visualization to create. Data visualization client program 60 compares relationship phrases 320 and 345 to the graphing rules to determine the type of visualization to create. In the depicted embodiment, data visualization client program 60 determines that, based on the graphing rules and relationship phrases 320 and 345, a bar graph will be visualized. The data points and labels are plotted according to the relationships between the data points. In another embodiment, data visualization client program 60 includes a setting that was pre-selected by the user to use a specific type of graph to visualize the data. For example, a user has pre-selected the settings of data visualization client program 60 to plot the data as a bar graph. In another embodiment, the user selects the type of graph each time data visualization client program 60 visualizes data.

Based on the determined graphing rules, data visualization client program 60 lists data points 315 and 330 and labels 310 and 325 in a spreadsheet and data visualization client program 60 creates bar graph 350.

Data point 330 and numeric value 315 are each represented by bars on bar graph 350. Label 325 is used to describe the bar that represents data point 330 and label 310 is used to describe the bar that represents numeric value 315. In the depicted embodiment, symbol 312 appears before data point 315 and symbol 327 appears before data point 330 to indicate that data point 312 and data point 330 are monetary values. In another embodiment, symbol 312 and symbol 327 do not appear in bar graph 350.

In the depicted embodiment, data point 335, label 340, and relationship phrase 345 are displayed on bar graph 350. In another embodiment, data point 335, label 340, and relationship phrase 345 are not displayed on bar graph 350. Data point 335, label 340, and relationship phrase 345 describe the comparison between data point 330 and data point 315. In one embodiment, a user may modify bar graph 350. For example, the user may add a title. In another example, the user may change labels.

FIG. 3C contains represents line graph 360 created by data visualization client program 60. Line graph 360 includes the numeric values and labels obtained from unstructured text 300 in FIG. 3A. In the depicted embodiment, data visualization client program 60 uses graphing rules and relationship phrases 320 and 345 to create a bar graph. Data visualization client program 60 prompts the user to approve or disapprove of the bar graph, and the user disapproves the bar graph. The user instructs data visualization client program 60 to create a line graph. Data visualization client program 60 lists data points 315 and 330 and labels 310 and 325 in a spreadsheet and data visualization client program 60 creates line graph 360.

Data point 330 and data point 315 are each represented by points on line graph 360. Label 325 is used to describe the point that represents numeric value 330 and label 310 is used to describe the point that represents data point 315. In the depicted embodiment, symbol 312 appears before data point 315 and symbol 327 appears before data point 330 to indicate that data point 312 and data point 330 are monetary values. In another embodiment, symbol 312 and symbol 327 do not appear in line graph 360.

In the depicted embodiment, data point 335, label 340, and relationship phrase 345 are displayed on line graph 360. In another embodiment, data point 335, label 340, and relationship phrase 345 are not displayed on bar graph 350. Data point 335, label 340, and relationship phrase 345 describe the comparison between data point 330 and data point 315. In one embodiment, a user may modify line graph 360. For example, the user may change the type of graph. In another example, the user may add more data points.

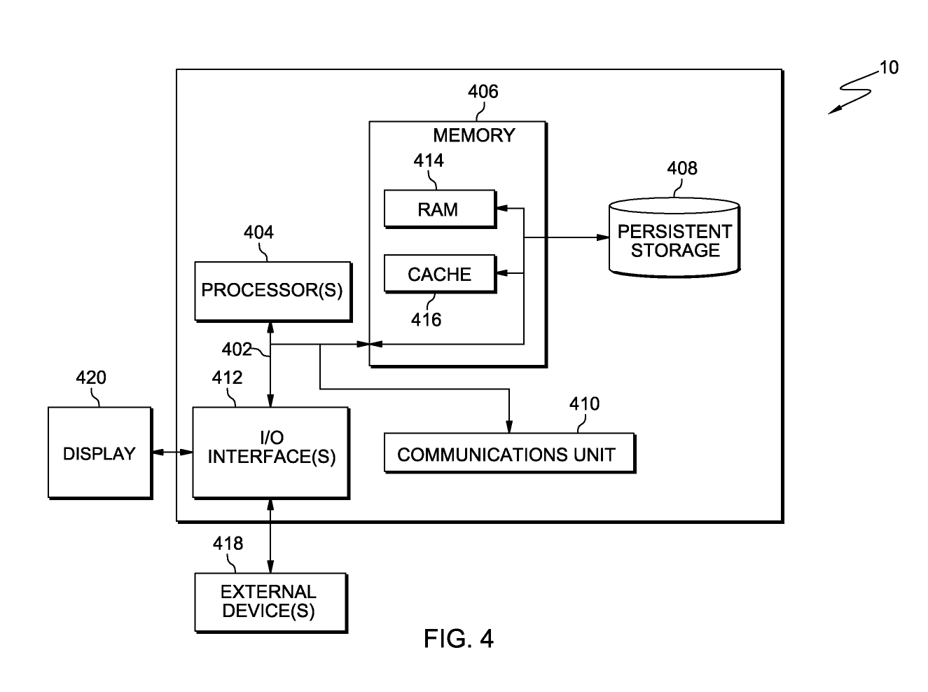

FIG. 4 depicts a block diagram of components of client computer 30 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Client computer 30 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Software program 50, data visualization client program 60, and phrase dictionary 80 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other servers or devices. In these examples, communications unit 410 includes one or more network interface cards. Communications unit 410 may provide communications through the use of either or both physical and wireless communications links. Software program 50 and data visualization client program 60 may be downloaded to persistent storage 408 of client computer 30 through the respective communications unit 410 of client computer 30.

I/O interface(s) 412 allows for input and output of data with other devices that may be connected to client computer 30. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., software program 50, data visualization client program 60, and phrase dictionary 80 can be stored on such portable computer-readable storage media and can be loaded onto persistent storage 408 of client computer 30, respectively, via the respective I/O interface(s) 412 of client computer 30.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for visualizing data related to unstructured text, the method comprising the steps of:
a computer identifying at least two data points in a portion of unstructured text of a document, a relationship between the at least two data points, and a label for each of the at least two data points;
the computer determining a type of graph based on the at least two data points, the relationship between the at least two data points, and the label for each of the at least two data points;
the computer causing the at least two data points and the label for each of the at least two data points, and the relationship between the at least two data points to be visualized on a graph of the type of graph determined; and
the computer causing the graph to be displayed in the document having the unstructured text.

2. The method of claim 1, further comprising the steps of:
the computer receiving an instruction to display the graph in a specific location in the document having the unstructured text; and
the computer causing the modified graph to be displayed in the specific location in the document having the unstructured text.

3. The method of claim 1, further comprising the steps of:
the computer receiving instructions to modify the graph; and
the computer causing the at least two data points and the label for each of the at least two data points, and the relationship between the at least two data points to be visualized on a modified graph based on the received instructions.

4. The method of claim 2, wherein the step of the computer receiving an instruction to display the graph in a specific location in the document having the unstructured text further comprises the computer receiving an instruction to embed the graph in the text of the document.

5. The method of claim 2, wherein the step of the computer receiving an instruction to display the graph in a specific location in the document having the unstructured text further comprises the computer prompting the user to select a location to display the graph.

6. The method of claim 1, wherein the step of the computer identifying at least two data points in a portion of unstructured text of a document, a relationship between the at least two data points, and a label for each of the at least two data points comprises:
the computer accessing a pre-defined dictionary comprising rules for identifying data points, relationships between data points, and labels for data points; and
the computer searching the portion of unstructured text for at least two data points in a portion of unstructured text of a document, a relationship between the at least two data points, and a label for each of the at least two data points based on the rules.

7. The method of claim 6, further comprising the prior steps of:
the computer receiving a request to modify the pre-defined dictionary:
the computer prompting a user to make modifications to the pre-defined dictionary;
the computer receiving the modifications to the pre-defined dictionary; and
the computer saving the modifications to the pre-defined dictionary.

8. A computer program product for visualizing data related to unstructured text, the computer program product comprising:
one or more computer-readable storage media and program instructions stored on the one or more computer-readable storage media, the program instructions comprising:
program instructions to identify at least two data points in a portion of unstructured text of a document, a relationship between the at least two data points, and a label for each of the at least two data points;
program instructions to determine a type of graph to create based on the at least two data points, the relationship between the at least two data points, and the label for each of the at least two data points;
program instructions to cause the at least two data points and the label for each of the at least two data points, and the relationship between the at least two data points to be visualized on a graph of the type of graph determined; and
program instructions to cause the modified graph to be displayed in the document having contains the unstructured text.

9. The computer program product of claim 8, further comprising:
program instructions, stored on the one or more computer-readable storage media, to receive an instruction to display the graph in a specific location in the document having the unstructured text; and
program instructions, stored on the one or more computer-readable storage media, to cause the modified graph to be displayed in the specific location in the document having the unstructured text.

10. The computer program product of claim 8, further comprising the steps of:
program instructions, stored on the one or more computer-readable storage media to receive instructions to modify the graph; and
program instructions, stored on the one or more computer-readable storage media to cause the at least two data points and the label for each of the at least two data points, and the relationship between the at least two data points to be visualized on a modified graph based on the received instructions.

11. The computer program product of claim 9, wherein the program instructions to receive an instruction to display the graph in a specific location in the document having the unstructured text comprise program instructions to receive an instruction to embed the graph in the text of the document.

12. The computer program product of claim 9, wherein the program instructions to receive an instruction to display the graph in a specific location in the document having the unstructured text comprise program instructions to prompt the user to select a location to display the graph.

13. The computer program product of claim 8, wherein the program instructions to identify at least two data points in a portion of unstructured text of a document, a relationship between the at least two data points, and a label for each of the at least two data points comprise:
program instructions to access a pre-defined dictionary comprising rules for identifying data points, relationships between data points, and labels for data points; and
program instructions to search the portion of unstructured text for at least two data points in a portion of unstructured text of a document, a relationship between the at least two data points, and a label for each of the at least two data points based on the rules.

14. The computer program product of claim 8, further comprising:
program instructions, stored on the one or more computer-readable storage media, to receive a request to modify the pre-defined dictionary:
program instructions, stored on the one or more computer-readable storage media, to prompt a user to make modifications to the pre-defined dictionary;
program instructions, stored on the one or more computer-readable storage media, to receive the modifications to the pre-defined dictionary; and
program instructions, stored on the one or more computer-readable storage media, to save the modifications to the pre-defined dictionary.

15. A computer system for visualizing data related to unstructured text, the computer system comprising:
one or more computer processors;
one or more computer-readable storage media;
program instructions stored on the computer-readable storage media for execution by at least one of the one or more processors, the program instructions comprising:
program instructions to identify at least two data points in a portion of unstructured text of a document, a relationship between the at least two data points, and a label for each of the at least two data points;
program instructions to determine a type of graph to create based on the at least two data points, the relationship between the at least two data points, and the label for each of the at least two data points;
program instructions to cause the at least two data points and the label for each of the at least two data points, and the relationship between the at least two data points to be visualized on a graph of the type of graph determined; and
program instructions to cause the modified graph to be displayed in the document having the unstructured text.

16. The computer system of claim 15, further comprising:
program instructions, stored on the one or more computer-readable storage media for execution by at least one of the one or more processors, to receive an instruction to display the graph in a specific location in the document having the unstructured text; and
program instructions, stored on the one or more computer-readable storage media for execution by at least one of the one or more processors, to cause the modified graph to be displayed in the specific location in the document having the unstructured text.

17. The computer system of claim 15, further comprising the steps of:
program instructions, stored on the one or more computer-readable storage media to receive instructions to modify the graph; and
program instructions, stored on the one or more computer-readable storage media to cause the at least two data points and the label for each of the at least two data points, and the relationship between the at least two data points to be visualized on a modified graph based on the received instructions.

18. The computer system of claim 16, wherein the program instructions to receive an instruction to display the graph in a specific location in the document having the unstructured text comprise program instructions to receive an instruction to embed the graph in the text of the document.

19. The computer system of claim 16, wherein the program instructions to receive an instruction to display the graph in a specific location in the document having the unstructured text comprise program instructions to prompt the user to select a location to display the graph.

20. The computer system of claim 15, wherein the program instructions to identify at least two data points in a portion of unstructured text of a document, a relationship between the at least two data points, and a label for each of the at least two data points comprise:
program instructions to access a pre-defined dictionary comprising rules for identifying data points, relationships between data points, and labels for data points; and
program instructions to search the portion of unstructured text for at least two data points in a portion of unstructured text of a document, a relationship between the at least two data points, and a label for each of the at least two data points based on the rules.
